(19) United States
(12) Patent Application Publication
(10) Pub. No.: US 2015/0201355 A1
(43) Pub. Date: Jul. 16, 2015

(54) SYSTEMS AND METHODS FOR ACCELERATED CELL RESELECTION

(71) Applicant: QUALCOMM Incorporated, San Diego, CA (US)

(72) Inventors: Ravi Kanth Kotreka, Hyderabad (IN); Harinath Reddy Patel, Hyderabad (IN); Mungal Singh Dhanda, Slough (GB); Kishore Kumar Yannakula, Hyderabad (IN); Simon Walke, Basingstoke (GB)

(73) Assignee: QUALCOMM Incorporated, San Diego, CA (US)

(21) Appl. No.: 14/152,350

(22) Filed: Jan. 10, 2014

(51) Int. Cl. H04W 36/00; H04W 68/02

(52) U.S. Cl. CPC H04W 36/0055; H04W 68/02

(57) ABSTRACT

A method for performing cell reselection by a wireless communication device is described. The method includes determining that the wireless communication device should perform reselection to a target cell from a serving cell. The method also includes determining that the wireless communication device does not have paging channel information of the target cell. The method further includes prioritizing reading paging channel information from a broadcast channel of the target cell over reading a paging channel of the serving cell.

### TECHNICAL FIELD

The present disclosure relates generally to communication systems. More specifically, the present disclosure relates to systems and methods for accelerated cell reselection.

### BACKGROUND

Wireless communication systems have become an important means by which many people worldwide have come to communicate. A wireless communication system may provide communication for a number of wireless communication devices, each of which may be serviced by one or more base stations.

Sometimes a wireless communication device will switch from one cell to a second cell. This may be referred to as cell reselection. Benefits may be realized by reducing the time of a cell reselection procedure. Additional benefits may be realized by reducing the amount of data that the wireless communication device processes in order to perform a cell reselection.

### SUMMARY

A method for performing cell reselection by a wireless communication device is described. The method includes determining that the wireless communication device should perform reselection to a target cell from a serving cell. The method also includes determining that the wireless communication device does not have paging channel information of the target cell. The method further includes prioritizing reading paging channel information from a broadcast channel of the target cell over reading a paging channel of the serving cell.

Determining that the wireless communication device does not have paging channel information of the target cell may be performed in response to determining that the wireless communication device should perform reselection to a target cell from a serving cell. Prioritizing reading paging channel information from a broadcast channel of the target cell over reading a paging channel of the serving cell may be performed in response to determining that the wireless communication device does not have paging channel information of the target cell. Determining that the wireless communication device does not have the paging channel information of the target cell may include determining that a system information type 3 (SI3) message of the target cell was not available in an internal stored list.

Prioritizing reading paging channel information from a broadcast channel of the target cell over reading a paging channel of the serving cell may include canceling reading the paging channel of the serving cell. The broadcast channel of the target cell may be read to obtain the paging channel information of the target cell. Reading the broadcast channel of the target cell to obtain the paging channel information of the target cell may be performed upon canceling reading the paging channel of the serving cell.

Reading the broadcast channel of the target cell to obtain the paging channel information of the target cell may include decoding an SI3 message of the target cell. The method may further include entering idle mode on the target cell upon decoding the SI3 message of the target cell without decoding other system information blocks on the broadcast channel of the target cell. Entering idle mode on the target cell upon decoding the SI3 message of the target cell without decoding other broadcast channel information from the target cell may include avoiding a page reorganization mode.

The cell reselection may be performed in a Universal Mobile Telecommunications System (UMTS). The wireless communication device may be a User Equipment (UE).

An apparatus for performing cell reselection is also described. The apparatus includes a processor, memory in electronic communication with the processor, and instructions stored in the memory. The instructions are executable by the processor to determine that the apparatus should perform reselection to a target cell from a serving cell. The instructions are also executable to determine that the apparatus does not have paging channel information of the target cell. The instructions are further executable to prioritize reading paging channel information from a broadcast channel of the target cell over reading a paging channel of the serving cell.

A wireless communication device for performing cell reselection is also described. The wireless communication device includes means for determining that the wireless communication device should perform reselection to a target cell from a serving cell. The wireless communication device also includes means for determining that the wireless communication device does not have paging channel information of the target cell. The wireless communication device further includes means for prioritizing reading paging channel information from a broadcast channel of the target cell over reading a paging channel of the serving cell.

A computer-program product for performing cell reselection is also described. The computer-program product includes a non-transitory computer-readable medium having instructions thereon. The instructions include code for causing a wireless communication device to determine that the wireless communication device should perform reselection to a target cell from a serving cell. The instructions also include code for causing the wireless communication device to determine that the wireless communication device does not have paging channel information of the target cell. The instructions further include code for causing the wireless communication device to prioritize reading paging channel information from a broadcast channel of the target cell over reading a paging channel of the serving cell.

### BRIEF DESCRIPTION OF THE DRAWINGS

FIG. 1 is a block diagram illustrating a wireless communication system with a wireless communication device, a serving cell and a target cell;

FIG. 2 is a block diagram illustrating a UMTS network operating according to described systems and methods;

FIG. 3 is a flow diagram of a method for performing accelerated cell reselection;

FIG. 4 is a block diagram illustrating a more detailed configuration of a wireless communication system with a wireless communication device, a serving cell and a target cell;

FIG. 5 is a flow diagram illustrating a detailed configuration of a method for performing accelerated cell reselection;

FIG. 6 is a flow diagram illustrating a more detailed configuration of a method for performing accelerated cell reselection;

FIG. 7 illustrates certain components that may be included within a wireless communication device; and

FIG. 8 illustrates certain components that may be included within a base station.

### DETAILED DESCRIPTION

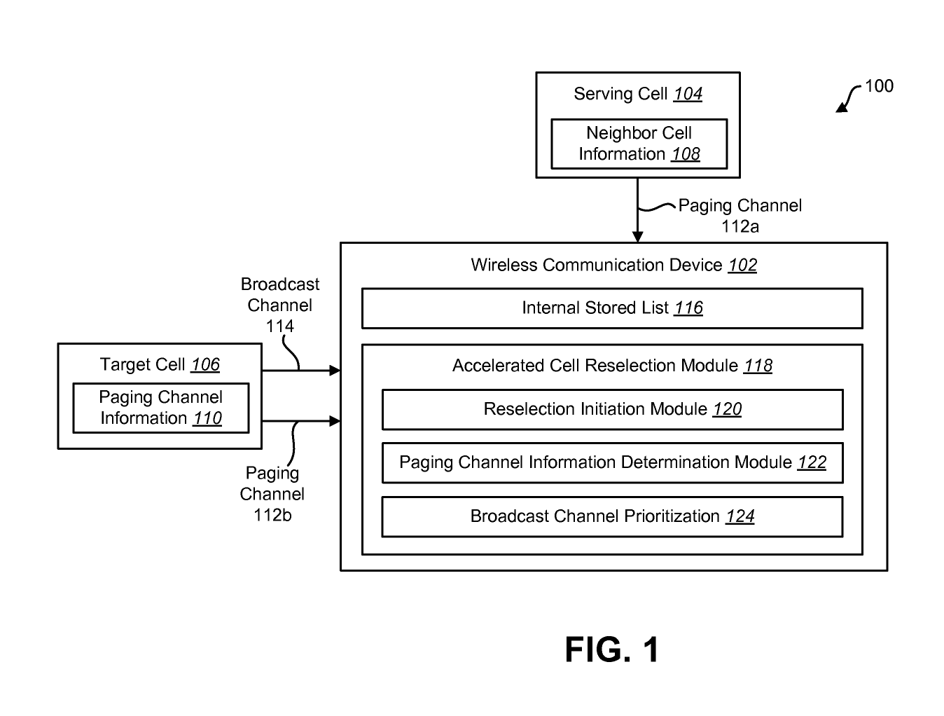

FIG. 1 is a block diagram illustrating a wireless communication system 100 with a wireless communication device 102, a serving cell 104 and a target cell 106. Wireless communication systems 100 are widely deployed to provide various types of communication content such as voice, data, and so on. Accelerated cell reselection may be performed on the wireless communication system 100 according to the systems and methods described herein.

The serving cell 104 and the target cell 106 may be provided by a base station. The term “cell” can refer to a base station and/or the coverage area of a base station depending on the context in which the term is used. A base station is a station that may communicate with one or more wireless communication devices 102. A base station may also be referred to as, and may include some or all of the functionality of an access point, a broadcast transmitter, a NodeB, an evolved NodeB, a base transceiver station, etc. The term “base station” will be used herein. Each base station may provide communication coverage for a particular geographic area. A base station may provide communication coverage for one or more wireless communication devices 102. The serving cell 104 may include one or more base stations. Each neighbor cell (including the target cell 106) may also include one or more base stations.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102 or base station) to extract transmit beamforming gain from communications received by the transmitting wireless device.

The wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, etc.

A wireless communication device 102 may communicate with zero, one or multiple base stations on the downlink and/or uplink at any given moment. The downlink (or forward link) refers to the communication link from a base station to a wireless communication device 102, and the uplink (or reverse link) refers to the communication link from a wireless communication device 102 to a base station.

The wireless communication device 102 may be camped on the serving cell 104. The term “camp” refers to a process in which the wireless communication device 102 monitors a cell for system information and paging information. The wireless communication device 102 may receive paging information on a paging channel 112a. The cell on which the wireless communication device 102 is camped is referred to as the serving cell 104.

While in idle mode, the wireless communication device 102 may be tuned to the paging channel 112a of the serving cell 104. The wireless communication device 102 may receive system information from the network 100 (e.g., public land mobile network (PLMN)). If the network 100 receives a call for the wireless communication device 102, the network 100 may know (in most cases) the registration area of the cell in which the wireless communication device 102 is camped. The network 100 can then send a paging message for the wireless communication device 102 on paging channels 112 of all the cells in the registration area. The wireless communication device 102 may then receive the paging message on the paging channel 112 of a cell in that registration area.

Furthermore, while in idle mode, the wireless communication device 102 may receive cell broadcast services. In one scenario, the wireless communication device 102 may receive neighbor cell information 108 from the serving cell 104. The neighbor cell information 108 may inform the wireless communication device 102 about neighbor cells (including the target cell 106). In one configuration, the neighbor cell information 108 may be included in a system information type 2 (SI2) message sent from the serving cell 104 to the wireless communication device 102. The wireless communication device 102 may receive system information from a neighbor cell on a broadcast channel 114 of the neighbor cell. The system information may include one of a system information type 3 (SI3) message or a system information type 4 (SI4) message. If the wireless communication device 102 receives either an SI3 message or an SI4 message, then the wireless communication device 102 knows that the neighbor cell is available and may perform cell reselection measurements using the system information.

While camped on the serving cell 104, the wireless communication device 102 may monitor the broadcast channel 114 of the neighbor cells to determine whether to perform a cell reselection. During this process, the wireless communication device 102 may verify if the network 100 (e.g., the PLMN) of a neighbor cell matches with the current camped serving cell 104 by decoding either of the SI3 message or the SI4 message.

Cell reselection may be performed to ensure that the wireless communication device 102 is on the best carrier available. In some configurations, cell reselection may be performed when any of the neighbor cells meet cell reselection criteria based on the system information acquired from the broadcast channel 114. For example, if the wireless communication device 102 determines that cell power is beyond a certain threshold, the wireless communication device 102 may initiate cell reselection. The wireless communication device 102 may also determine that another cell reading is better in terms of signal power than the signal power of the serving cell 104. For instance, when the wireless communication device 102 is moving from the coverage area of the serving cell 104 into an area where the target cell 106 is better, the wireless communication device 102 may determine that the target cell 106 signal power is better and the cell reselection procedure may begin. In some configurations, the wireless communication device 102 may store the received system information in an internal stored list 116.

The wireless communication device 102 may determine that it should perform a reselection to a target cell 106 from the serving cell 104. The wireless communication device 102 may evaluate whether a neighbor cell is a cell reselection candidate based on the acquired system information. In one configuration, upon decoding either the SI3 message or the SI4 message, the wireless communication device 102 may determine that the cell reselection criteria are met for the target cell 106 based on parameters included in the system information. The wireless communication device 102 may initiate a cell reselection from the serving cell 104 to the target cell 106.

In a typical cell reselection procedure, upon the start of a cell reselection process, the wireless communication device 102 is expected to read all the system information on the target cell 106 again to see if there are any changes in cell reselection criteria (e.g., to determine if the reselection criteria are as good as the last time). If the cell reselection criteria are sufficient, the wireless communication device 102 may convert to the target cell 106 and perform a camping procedure by reading all available system information on the broadcast channel 114. Upon acquiring (e.g., decoding) all of the available system information, the wireless communication device 102 may then go into idle mode on the target cell 106.

The wireless communication device 102 may connect to the target cell 106 using the system information obtained on the broadcast channel 114. For example, the wireless communication device 102 may tune to the absolute radio frequency channel number (ARFCN) of the target cell 106. The ARFCN may define a pair of radio frequency (RF) channel frequencies for uplink and downlink use. The wireless communication device 102 may then acquire (e.g., receive and decode) all system information blocks from the broadcast channel 114 of the target cell 106. Upon acquiring the available system information blocks from the target cell 106, the wireless communication device 102 may tune to the paging channel 112b of the target cell 106 for idle mode activity.

In some configurations, paging channel information 110 for the target cell 106 may be obtained from a system information type 3 (SI3) message. The paging channel information 110 may provide metric parameters for the paging channel 112b. The paging channel information 110 may be used by the wireless communication device 102 to tune to the paging channel 112b of the target cell 106 upon cell reselection.

In some implementations, the wireless communication device 102 may directly enter idle mode on the target cell 106 upon cell reselection if the paging channel information 110 is acquired prior to cell reselection. For example, the wireless communication device 102 may have received the SI3 message on the broadcast channel 114 of the target cell 106 while camped on the serving cell 104 and stored the SI3 message in an internal stored list 116. Therefore, upon cell reselection, the wireless communication device 102 may start reading the paging channel information on the target cell 106 using the paging channel information 110 from the SI3 message. In this way, the wireless communication device 102 may perform a cell reselection faster because of the stored paging channel information 110 acquired during the idle mode activities on the serving cell 104.

In some circumstances the wireless communication device 102 may not acquire paging channel information 110 prior to initiating cell reselection. For example, the SI3 message broadcast from the target cell 106 may collide with a paging channel 112a read of the serving cell 104. In this case, the wireless communication device 102 may acquire an SI4 message instead of an SI3 message. If the wireless communication device 102 acquires an SI4 message during the broadcast channel 114 decode, the wireless communication device 102 may store the SI4 message in the internal stored list 116. However, an SI4 message may not contain paging channel information 110. Therefore, when the wireless communication device 102 performs reselection to the target cell 106 (e.g., switches from camping on the serving cell 104 to camping on the target cell 106), the wireless communication device 102 would not be able to immediately start reading the paging channel 112b of the target cell 106. In other words, the wireless communication device 102 may not have the paging channel metric parameters if the wireless communication device 102 received an SI4 message.

In a typical cell reselection procedure, the wireless communication device 102 may enter into a page reorganization mode (e.g., PAGE REORG MODE) to acquire the paging channel information 110. The wireless communication device 102 may read all the paging and system information blocks available on the broadcast channel 114 to acquire the SI3 message before entering a normal page mode. However, this consumes battery power, as well as time. By entering the page reorganization mode, it takes a longer time for the wireless communication device 102 to be on the target cell 106 in idle mode and retune to the paging channel 112b for a mobile terminated (MT) call.

The problems associated with the page reorganization mode may be compounded in multi-subscriber identity module (SIM) devices. A wireless communication device 102 that is a multi-SIM device may have multiple subscriptions associated with each SIM. Each of the multiple subscriptions may share one radio frequency (RF). The subscriptions may compete for resources and the resources may be time multiplexed between the multiple subscriptions. Missing a page occasion because of idle mode activities of one subscription may result in a longer delay for each subscription and may lead to increased cell reselection process time. This may waste time, as well as resources.

In one configuration, the wireless communication device 102 may include an accelerated cell reselection module 118. If the wireless communication device 102 does not have paging channel information 110 (e.g., an SI4 message for the target cell 106 is stored in the internal stored list 116), then the accelerated cell reselection module 118 may implement faster cell reselection.

The accelerated cell reselection module 118 may include a reselection initiation module 120. The reselection initiation module 120 may determine that the wireless communication device 102 should switch to a target cell 106 from a serving cell 104. While the wireless communication device 102 is camped on the serving cell 104 in idle mode, the wireless communication device 102 may receive neighbor cell information 108. The wireless communication device 102 may monitor the neighbor cells based on the neighbor cell information 108.

While monitoring the neighbor cells, the wireless communication device 102 may acquire one of either an SI3 message or an SI4 message from each of the neighbor cells (including the target cell 106). The wireless communication device 102 may store the SI3 messages and SI4 messages in the internal stored list 116. The reselection initiation module 120 may evaluate cell reselection parameters obtained from the SI3 message or the SI4 message. The reselection initiation module 120 may determine that the target cell 106 meets the cell reselection criteria and may initiate cell reselection to the target cell 106.

A paging channel information determination module 122 may determine whether the wireless communication device 102 lacks the paging channel information 110 of the target cell 106. In one configuration, the paging channel information determination module 122 may determine that the SI3 message of the target cell 106 is not stored in the internal stored list 116. For example, the wireless communication device 102 may have no stored system information associated with the target cell 106 or the wireless communication device 102 may have an SI4 message stored in the internal stored list 116.

The broadcast channel prioritization module 124 may prioritize reading paging channel information 110 from a broadcast channel 114 of the target cell 106 over reading a paging channel 112a of the serving cell 104. The broadcast channel prioritization module 124 may acquire the paging channel information 110 of the target cell 106 before a cell reselection to the target cell 106 is performed. In one configuration, the broadcast channel prioritization module 124 may read the broadcast channel 114 of the target cell 106 to obtain the paging channel information 110 of the target cell 106. The broadcast channel prioritization module 124 may then cancel reading the paging channel 112a of the serving cell 104. In another configuration, the broadcast channel prioritization module 124 may cancel reading the paging channel 112a of the serving cell 104 before reading the broadcast channel 114 of the target cell 106 to obtain the paging channel information 110 of the target cell 106.

In one configuration, the paging channel information 110 may be obtained by decoding the SI3 message of the target cell 106 before moving onto the target cell 106. The wireless communication device 102 may decode the SI3 message without decoding other system information blocks on the broadcast channel 114 of the target cell 106. Upon obtaining the paging channel information 110 of the target cell 106, the wireless communication device 102 may perform cell reselection to the target cell 106 and directly enter idle mode (e.g., normal page mode) on the target cell 106.

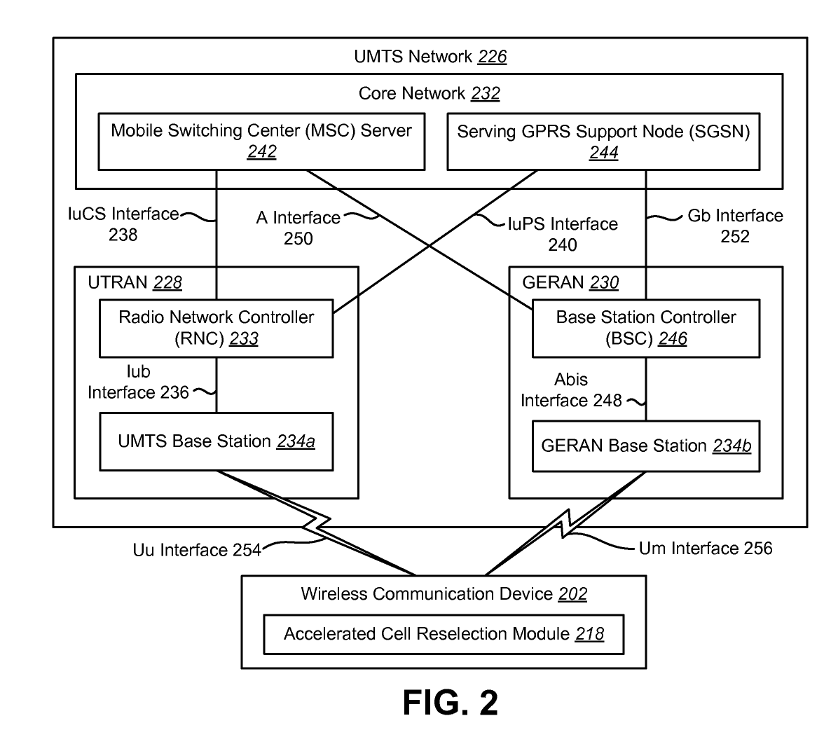

FIG. 2 is a block diagram illustrating a UMTS network 226 operating according to described systems and methods. The UMTS network 226 may be used to perform accelerated cell reselection as described in connection with FIG. 1. In one configuration, the UMTS network 226 may include a UMTS radio access network (UTRAN) 228, which may operate according to UMTS standards.

The UTRAN 228 may include one or more UMTS base stations 234a and the control equipment for the UMTS base stations 234a (e.g., one or more radio network controllers (RNCs) 233). The UTRAN 228 provides an air interface access method for the wireless communication device 202. Connectivity is provided between the wireless communication device 202 and a core network 232 by the UTRAN 228. The core network 232 may include a mobile switching center (MSC) 242 and a serving general packet radio service (GPRS) support node (SGSN) 244. The MSC 242 may provide circuit switched (CS) services (e.g., voice calls), while the SGSN 244 may provide packet switched (PS) services (e.g., data).

The UTRAN 228 is connected internally or externally to other functional entities by various interfaces. The UTRAN 228 is attached to the MSC 242 in the core network 232 via an IuCS interface 238. The UTRAN 228 is attached to the SGSN 244 via an IuPS interface 240. The RNCs 233 support these interfaces. In addition, the RNCs 233 manage a set of UMTS base stations 234a through Iub interfaces 236. The Uu interface 254 connects a UMTS base station 234a with the wireless communication device 202. In one configuration, the wireless communication device 202 may include an accelerated cell reselection module 218. The wireless communication device 202 may communicate with one or more UMTS base stations 234a via a UMTS access stratum (AS).

The UMTS network 226 may also include a GSM EDGE Radio Access Network (GERAN) 230, which may operate according to Global System for Mobile Communications (GSM) standards. The GERAN 230 may include one or more GERAN base stations 234b and the control equipment for the GERAN base stations 234b (e.g., one or more base station controllers (BSCs) 246). The GERAN 230 provides an air interface access method for the wireless communication device 202. Connectivity is provided between the wireless communication device 202 and the core network 232 by the GERAN 230.

The GERAN 230 is attached to the MSC 242 in the core network 232 via an A interface 250. The GERAN 230 is attached to the SGSN 244 via a Gb interface 252. The base station controllers (BSCs) 246 support these interfaces. In addition, the BSCs 246 manage a set of GERAN base stations 234b through Abis interfaces 248. The Um interface 256 connects a GERAN base station 234b with the wireless communication device 202. In one configuration, the wireless communication device 202 may communicate with one or more GERAN base stations 234b via a GERAN access stratum (AS).

The UMTS network 226 may be further connected to additional networks outside the UMTS network 226, such as a corporate intranet, the Internet, or a conventional public switched telephone network (not shown). The UMTS network 226 may transport data packets between each wireless communication device 202 and such outside networks.

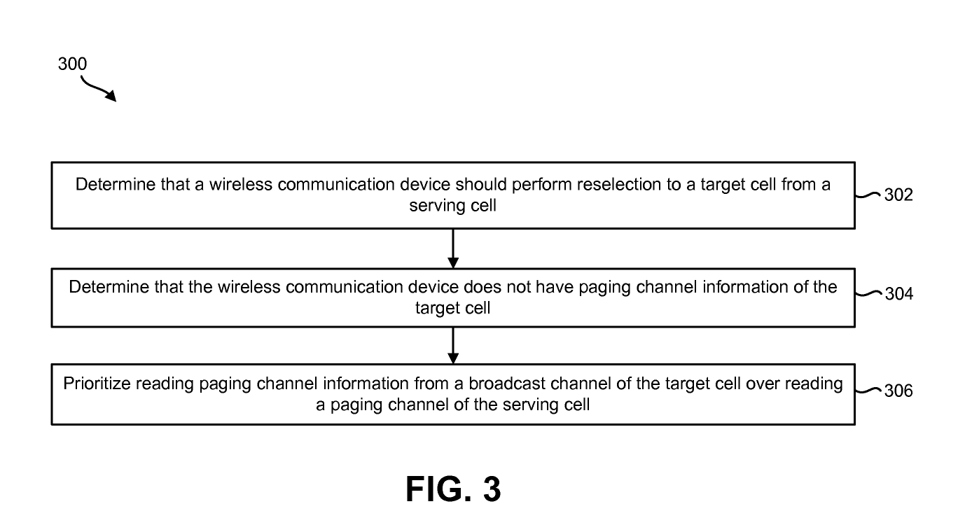

The wireless communication device 202 may be camped on a serving cell 104 provided by one or more of the UMTS base stations 234a and/or one or more of the GERAN base stations 234b. The wireless communication device 102 may initiate a cell reselection to a target cell 106 provided by one or more of the UMTS base stations 234a or the GERAN base stations 234b. The wireless communication device 202 may perform an accelerated cell reselection to switch to the target cell 106 from the serving cell 104, as described in more detail in connection with FIG. 3.

FIG. 3 is a flow diagram of a method 300 for performing accelerated cell reselection. The method 300 may be performed by a wireless communication device 102. In one configuration, the wireless communication device 102 may operate on a UMTS network 226 as described above in connection with FIG. 2.

The wireless communication device 102 may determine 302 that the wireless communication device 102 should perform reselection to a target cell 106 from a serving cell 104. While camped on the serving cell 104 in idle mode, the wireless communication device 102 may receive neighbor cell information 108. In one configuration, the neighbor cell information 108 may be included in a system information type 2 (SI2) message sent from the serving cell 104 to the wireless communication device 102. The neighbor cell information 108 may identify neighbor cells (including the target cell 106) that the wireless communication device 102 may monitor as potential reselection candidates.

While monitoring the neighbor cells, the wireless communication device 102 may acquire one of either an SI3 message or an SI4 message from each of the neighbor cells. The wireless communication device 102 may store the SI3 messages and SI4 messages in an internal stored list 116. The wireless communication device 102 may evaluate cell reselection criteria based on parameters obtained from the SI3 message or the SI4 message. The wireless communication device 102 may determine 302 that the target cell 106 meets the cell reselection criteria and may initiate a cell reselection to the target cell 106.

The wireless communication device 102 may determine 304 that the wireless communication device 102 does not have paging channel information 110 of the target cell 106. In one configuration, the wireless communication device 102 may determine that the SI3 message of the target cell 106 was not available in the internal stored list 116. If the wireless communication device 102 receives and stores an SI4 message from the target cell 106 (as opposed to an SI3 message), then the wireless communication device 102 may not have the paging channel information 110 of the target cell 106 because channel information 110 is included in an SI3 message. In some scenarios, the wireless communication device 102 may not receive an SI3 message from the target cell 106 when the SI3 message broadcast collides with a paging channel 112a read on the serving cell 104.

The wireless communication device 102 may prioritize 306 reading paging channel information 110 from a broadcast channel 114 of the target cell 106 over reading a paging channel 112a of the serving cell 104. At the point of cell reselection, the wireless communication device 102 may delay the cell reselection. The wireless communication device 102 may acquire the SI3 message by suspending the idle mode activities of the serving cell 104. For example, the wireless communication device 102 may cancel reading the paging channel 112a of the serving cell 104. The wireless communication device 102 may then read the broadcast channel 114 of the target cell 106 to obtain the paging channel information 110 of the target cell. In one configuration, the paging channel information 110 may be obtained by decoding the SI3 message of the target cell 106 before moving onto the target cell 106. The wireless communication device 102 may decode the SI3 message without decoding other system information blocks on the broadcast channel 114 (e.g., broadcast channel information) of the target cell 106.

By delaying the cell reselection (even though the cell reselection criteria is met) and acquiring the paging channel information 110 of the target cell 106, the wireless communication device 102 may directly enter normal page mode in the target cell 106. Therefore, the wireless communication device 102 may enter idle mode on the target cell 106 faster. Furthermore, battery consumption may be reduced by avoiding a page reorganization mode. In other words, by avoiding page reorganization mode, the wireless communication device 102 may read fewer blocks, which results in battery savings.

Delaying the cell reselection may result in missing one discontinuous reception (DRX) period on the serving cell 104. However, by acquiring the paging channel information 110 of the target cell 106 before cell reselection, the wireless communication device 102 may be camped on the target cell 106 in the fastest time possible. It should be noted that the loss of paging on the serving cell 104 because of the missed DRX period would be offset by paging repetition of the network 100. By virtue of paging repetition, the wireless communication device 102 may answer the page in the target cell 106 because the wireless communication device 102 has already decoded the paging channel parameters of the target cell 106.

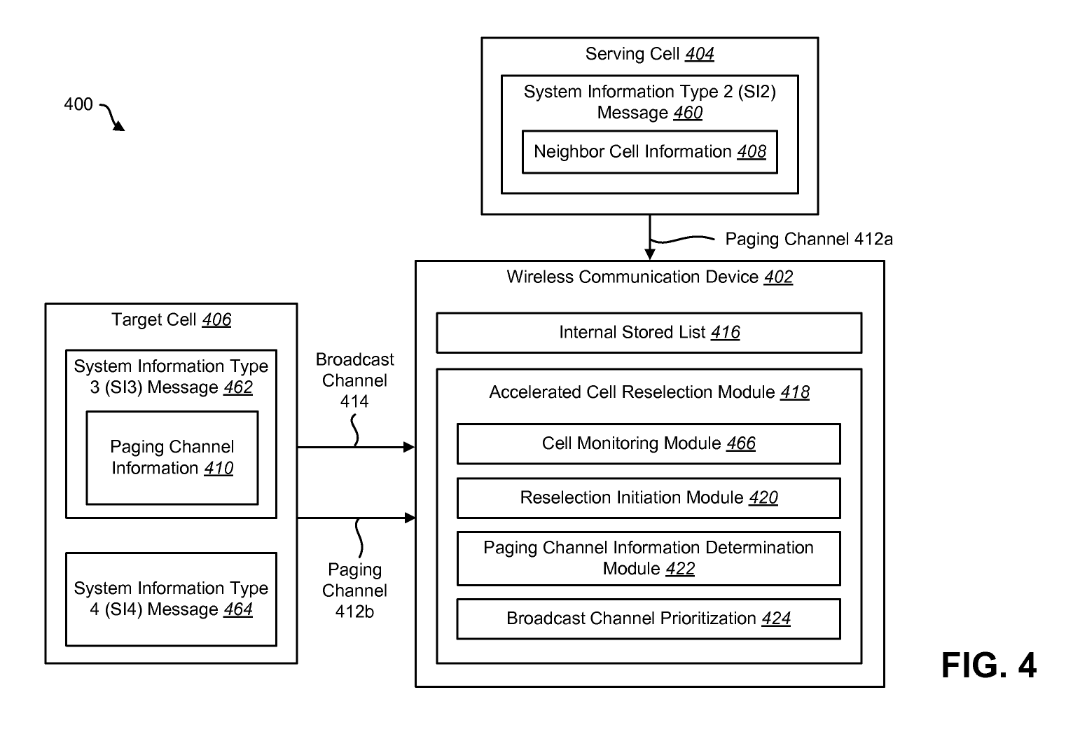

FIG. 4 is a block diagram illustrating a more detailed configuration of a wireless communication system 400 with a wireless communication device 402, a serving cell 404 and a target cell 406. The wireless communication device 402 illustrated in FIG. 4 may be similar to the wireless communication device 102 described in connection with FIG. 1.

The wireless communication device 402 may be camped on the serving cell 404. A cell monitoring module 466 may receive a system information type 2 (SI2) message 460 from the serving cell 404. The SI2 message 460 may include neighbor cell information 408 that informs the wireless communication device 402 about neighbor cells (including the target cell 406).

While camped on the serving cell 404 in idle mode, the cell monitoring module 466 may monitor the broadcast channel 414 of neighbor cells based on the neighbor cell information 408 included in the SI2 message 460. The cell monitoring module 466 may obtain one of an SI3 message 462 or an SI4 message 464 from a neighbor cell. The cell monitoring module 466 may store the SI3 messages 462 and the SI4 messages 464 in an internal stored list 416. An SI3 message 462 may include paging channel information 410.

In some instances, the wireless communication device 402 may not receive an SI3 message 462 from the target cell 406 when the SI3 message 462 broadcast collides with a paging channel 412a read on the serving cell 404. Table (1) provides a broadcast channel/paging channel collision matrix.

TABLE (1)

| Paging DRX | | SI1 | SI2 | SI2bis | SI2ter | SI2q | SI3 | SI4 | SI13 |
|---|---|---|---|---|---|---|---|---|---|
| Mfrms | ms | TC 0 | TC 1 | TC 5 | TC | TC | TC | TC | TC |
| | | | | | 5/4 | 5/4/5 | 2, 6 | 3, 7 | 4/0 |
| 2 | 471 | N, 1/4 | N, 1/4 | N, 1/4 | N, 1/4 | N, 1/4 | N, 1/2 | N, 1/2 | N, 1/4 |
| 3 | 706 | N, 1/8 | N, 1/8 | N, 1/8 | N, 1/8 | N, 1/8 | N, 1/4 | N, 1/4 | N, 1/8 |
| 4 | 941 | N, 1/2 | N, 1/2 | N, 1/2 | N, 1/2 | N, 1/2 | Y | Y | N, 1/2 |
| 5 | 1177 | N, 1/8 | N, 1/8 | N, 1/8 | N, 1/8 | N, 1/8 | N, 1/4 | N, 1/4 | N, 1/8 |
| 6 | 1412 | N, 1/4 | N, 1/4 | N, 1/4 | N, 1/4 | N, 1/4 | N, 1/2 | N, 1/2 | N, 1/4 |
| 7 | 1648 | N, 1/8 | N, 1/8 | N, 1/8 | N, 1/8 | N, 1/8 | N, 1/4 | N, 1/4 | N, 1/8 |
| 8 | 1883 | Y | Y | Y | Y | Y | Y | Y | Y |
| 9 | 2118 | N, 1/8 | N, 1/8 | N, 1/8 | N, 1/8 | N, 1/8 | N, 1/4 | N, 1/4 | N, 1/8 |

In Table (1), “N” indicates no persistent collision and the ratio represents the collision rate of a paging channel 412a with a corresponding system information read. In the case of no persistent collision (e.g., “N”), the paging channel 412a reception may be given priority over a broadcast channel 414 read. “Y” indicates that persistent collision may occur. In the case of persistent collision (e.g., “Y”), the broadcast channel 414 may be given priority over a paging channel 412a read. The page repetition factor for a paging channel discontinuous reception (DRX) is expressed in multi-frames (Mfrms) and milliseconds (ms).

In one configuration, TDMA frames may be numbered by a frame number (FN). The frame number may be cyclic and may have a range of 0 to FN_MAX, where FN_MAX=(26×51×2048)−1=2715647. The frame number may be incremented at the end of each TDMA frame.

The complete cycle of TDMA frame numbers from 0 to FN_MAX may be defined as a hyperframe. A hyperframe may include 2048 superframes, where a superframe is defined as 26×51 TDMA frames. In another implementation, a hyperframe may include 1024 superframes where a superframe is defined as 52×51 TDMA frames. A 26-multiframe, comprising 26 TDMA frames, may be used to support traffic and associated control channels. A 51-multiframe, comprising 51 TDMA frames, may be used to support broadcast, common control and stand-alone dedicated control (and associated control) channels. Therefore, a superframe may be considered as 51 traffic/associated control multiframes or 26 broadcast/common control multiframes. A 52-multiframe, comprising two 26-multiframes, may be used to support packet data traffic and control channels. The hyperframe may have a substantially longer period than a superframe to accommodate encryption processes which use FN as an input parameter.

System information (e.g., an SI3 message 462 or SI4 message 464) may be periodically broadcast at particular intervals. In order to facilitate the operation of wireless communication devices 402, system information messages may be transmitted in defined multiframes and defined blocks within one multiframe. Furthermore, for some system information messages, the position where the system information messages are transmitted is contained in other system information messages. The mapping of broadcast channel 414 messages is indicated in Table (1), where TC indicates when a system information message is sent. In one configuration, TC may be defined as (FN DIV 51) mod (8).

The broadcast channel 414 (or broadcast control channel) may broadcast general information on a base transceiver station per base transceiver station basis. A broadcast channel 414 may include multiple parameters. A BS_PA_MFRMS parameter may indicate the number of 51-multiframes between transmission of paging messages to wireless communication devices 402 of the same paging group. The BS_PA_MFRMS parameter may include 3 bits (before channel coding) that range from 2 to 9, as indicated in Table (2).

TABLE (2)

| Bits | | | | Multiframes period for transmission of PAGING |
|---|---|---|---|---|
| 3 | 2 | 1 | ms | REQUEST messages to the same paging subgroup |
| 0 | 0 | 0 | 471 | 2 |
| 0 | 0 | 1 | 706 | 3 |
| 0 | 1 | 0 | 941 | 4 |
| 0 | 1 | 1 | 1177 | 5 |
| 1 | 0 | 0 | 1412 | 6 |
| 1 | 0 | 1 | 1648 | 7 |
| 1 | 1 | 0 | 1883 | 8 |
| 1 | 1 | 1 | 2118 | 9 |

A system information broadcast of one cell may collide with a paging channel 412 of another cell. Whether the wireless communication device 402 receives an SI3 message 462 or SI4 message 464 may depend on whether the broadcast channel 414 is in collision with a page read (e.g., a page read of another cell or a serving cell page read).

Table (1) gives the probability of a page collision for a system information broadcast. The page can have a varied repetition time (e.g., the page repetition factor in the second column) where the page gets repeated. For example, for a page repetition factor of 941 ms, there is a 1 in 2 (½) chance that a page will collide with the system information type 1 (SI1) broadcast.

For the 941 ms page repetition factor, SI3 or SI4 will experience a constant collision with a page read. In this case, the wireless communication device 402 may either receive SI3 or SI4. For a collision with SI3, the wireless communication device 402 would have a stored SI4 message 464. For a collision with SI4, the wireless communication device 402 would have a stored SI3 message 462.

The system information may be given priority, but the wireless communication device 402 would not have the SI3 information before the cell reselection. Therefore, the described systems and methods provide for abandoning the paging channel 412 read on the serving cell 404 and obtaining an SI3 message 462 of the target cell 406.

In one configuration, the wireless communication device 402 may include an accelerated cell reselection module 418. If the wireless communication device 402 does not have paging channel information 410 (e.g., if an SI3 message 462 is not stored in the internal stored list 416 or an SI4 message 464 for the target cell 406 is stored in the internal stored list 416), then the accelerated cell reselection module 418 may implement faster cell reselection.

The accelerated cell reselection module 418 may include a reselection initiation module 420. The reselection initiation module 420 may evaluate cell reselection parameters obtained from the SI3 message 462 or the SI4 message 464. The reselection initiation module 420 may determine that the target cell 406 meets the cell reselection criteria and may initiate cell reselection to the target cell 406.

The paging channel information determination module 422 may determine whether the wireless communication device 402 lacks the paging channel information 410 of the target cell 406. In one configuration, the paging channel information determination module 422 may determine that the SI3 message 462 of the target cell 406 is not stored in the internal stored list 416. In other words, if the wireless communication device 402 received and stored an SI4 message 464 from the target cell 406, the paging channel information determination module 422 may determine that the wireless communication device 402 does not have the paging channel information 410 of the target cell 406.

The broadcast channel prioritization module 424 may prioritize reading an SI3 message 462 from a broadcast channel 414 of the target cell 406 over reading a paging channel 412a of the serving cell 404. The broadcast channel prioritization module 424 may acquire the SI3 message 462 of the target cell 406 before a cell reselection to the target cell 406 is performed. The broadcast channel prioritization module 424 may cancel reading the paging channel 412a of the serving cell 404. The broadcast channel prioritization module 424 may then read the broadcast channel 414 of the target cell 406 to decode the SI3 message 462 of the target cell 406 to obtain the paging channel information 410. Upon cell reselection to the target cell 406, the wireless communication device 402 may use the paging channel information 410 to tune to the paging channel 412b of the target cell 406 for idle mode activity.

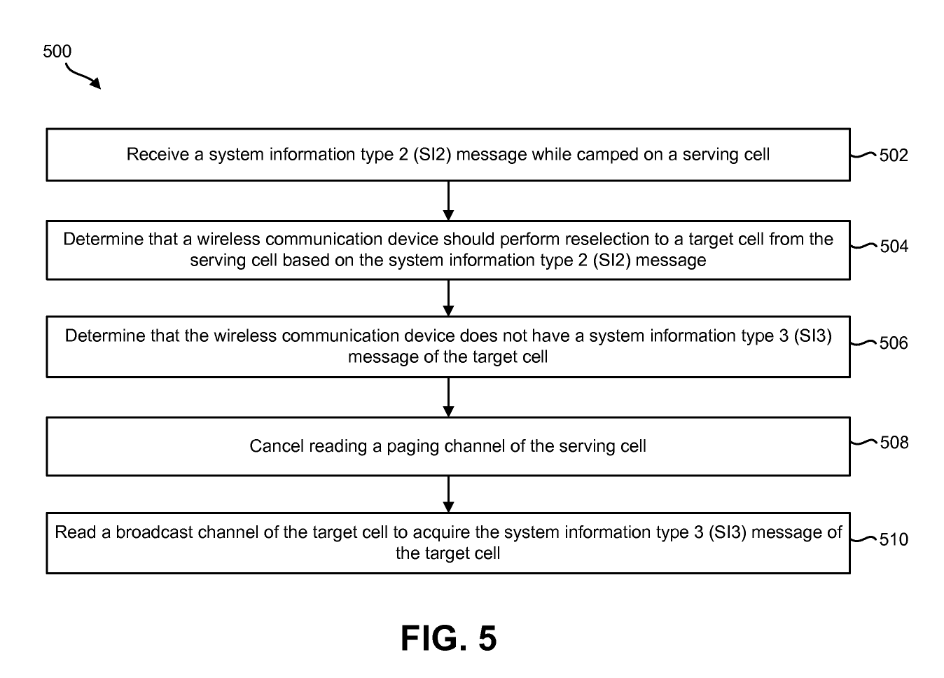

FIG. 5 is a flow diagram illustrating a detailed configuration of a method 500 for performing accelerated cell reselection. The method 500 may be performed by a wireless communication device 402. In one configuration, the wireless communication device 402 may operate on a UMTS network 226 as described above in connection with FIG. 2.

The wireless communication device 402 may receive 502 a system information type 2 (SI2) message 460 while camped on a serving cell 404. The SI2 message 460 may include neighbor cell information 408 that informs the wireless communication device 402 about neighbor cells (including a target cell 406).

The wireless communication device 402 may determine 504 that the wireless communication device 402 should perform reselection to the target cell 406 from the serving cell 404 based on the SI2 message 460. The wireless communication device 402 may acquire one of an SI3 message 462 or an SI4 message 464 from each of the neighbor cells included in the SI2 message 460. For example, the wireless communication device 402 may monitor the broadcast channel 414 of a neighbor cell to decode an SI3 message 462 or an SI4 message 464. The wireless communication device 402 may store the obtained SI3 messages 462 and SI4 messages 464 in an internal stored list 416.

The wireless communication device 402 may evaluate cell reselection parameters obtained from the SI3 message 462 or the SI4 message 464. The wireless communication device 402 may determine that the target cell 406 meets cell reselection criteria.

The wireless communication device 402 may determine 506 that the wireless communication device 402 does not have an SI3 message 462 of the target cell 406. If the wireless communication device 402 received and stored an SI4 message 464 in the internal stored list 416, then the wireless communication device 402 may not have the SI3 message 462. In some scenarios, the wireless communication device 402 may not receive the SI3 message 462 when the SI3 message 462 broadcast from the target cell 406 collides with the paging channel 412a read of the serving cell 404, as illustrated in Table (1).

The wireless communication device 402 may cancel 508 reading the paging channel 412a of the serving cell 404. Before performing cell reselection to the target cell 406, the wireless communication device 402 may read 510 the broadcast channel 414 of the target cell 406 to acquire the SI3 message 462 of the target cell 406. The wireless communication device 402 may obtain paging channel information 410 from the SI3 message 462 to tune to the paging channel 412b of the target cell 406 for idle mode activity.

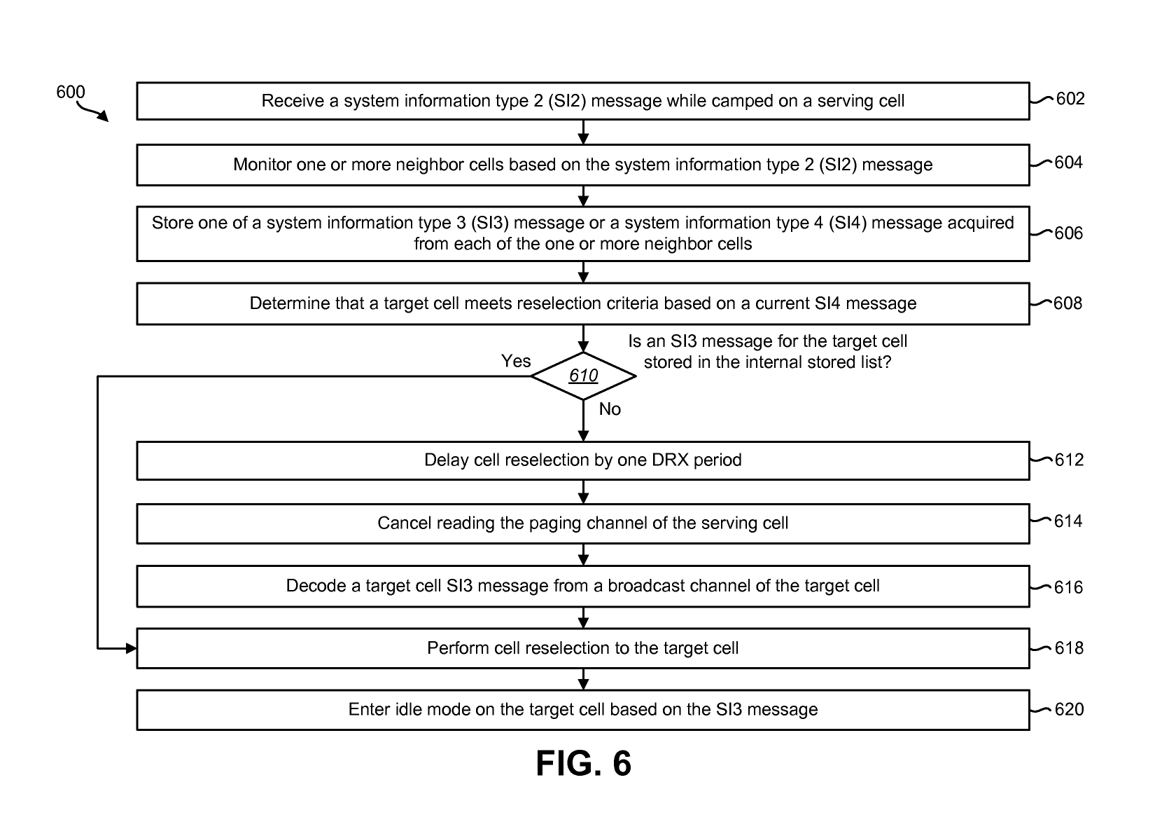

FIG. 6 is a flow diagram illustrating a more detailed configuration of a method 600 for performing accelerated cell reselection. The method 600 may be performed by a wireless communication device 402. In one configuration, the wireless communication device 402 may operate on a UMTS network 226 as described above in connection with FIG. 2.

The wireless communication device 402 may receive 602 a system information type 2 (SI2) message 460 while camped on a serving cell 404. Upon decoding the SI2 message 460, the wireless communication device 402 may acquire neighbor cell information 408 for one or more neighbor cells (including the target cell 406).

The wireless communication device 402 may monitor 604 the one or more neighbor cells based on the SI2 message 460. The wireless communication device 402 may monitor 604 the broadcast channel 414 of the one or more neighbor cells included in the SI2 message 460. The wireless communication device 402 may acquire one of a system information type 3 (SI3) message 462 or a system information type 4 (SI4) message 464 from the broadcast channel 414 of a neighbor cell.

The wireless communication device 402 may store 606 the SI3 message 462 or the SI4 message 464 acquired from each of the one or more neighbor cells. In one configuration, the wireless communication device 402 may store the SI3 messages 462 and SI4 messages 464 in an internal stored list 416.

The wireless communication device 402 may determine 608 that a target cell 406 meets reselection criteria based on a current SI4 message 464. The wireless communication device 402 may receive an SI4 message 464 in the most recent broadcast from the target cell 106. In some circumstances, the wireless communication device 402 may receive an SI4 message 464 if the SI3 message 462 broadcast collides with the page read of the serving cell 404. The current SI4 message 464 may be the same message stored in the internal stored list 416, or the current SI4 message 464 may be a different message. In other words, the SI3 message 462 or the SI4 message 464 stored in the internal stored list 416 may be acquired before the current SI4 message 464. The wireless communication device 402 may evaluate cell reconfiguration parameters obtained from the current SI4 message 464 of the target cell 406 to determine that cell reselection criteria are met.

The wireless communication device 402 may determine 610 whether an SI3 message 462 for the target cell 406 is stored in the internal stored list 416. If the wireless communication device 402 determines 610 that an SI3 message 462 is stored in the internal stored list 416, then the wireless communication device 402 may acquire paging channel information 410 from the stored SI3 message 462. The wireless communication device 402 may perform 618 cell reselection to the target cell 406. The wireless communication device 402 may enter 620 idle mode on the target cell 406 based on the SI3 message 462. The wireless communication device 402 may tune to the paging channel 412b of the target cell 406 by using the paging channel information 410 obtained from the stored SI3 message 462.

If the wireless communication device 402 determines 610 that an SI3 message 462 is not stored in the internal stored list 416, then the wireless communication device 402 may delay 612 cell reselection by one discontinuous reception (DRX) period. The wireless communication device 402 may cancel 614 reading the paging channel 412a of the serving cell 404. The wireless communication device 402 may decode 616 the target cell 406 SI3 message 462 from a broadcast channel 414 of the target cell 406.

Upon decoding the SI3 message 462, the wireless communication device 402 may perform 618 cell reselection to the target cell 406. The wireless communication device 402 may enter 620 idle mode on the target cell 406 based on the SI3 message 462. In this case, the wireless communication device 402 may tune to the paging channel 412b of the target cell 406 by using the paging channel information 410 obtained from the SI3 message 462 acquired during the delayed cell reselection period.

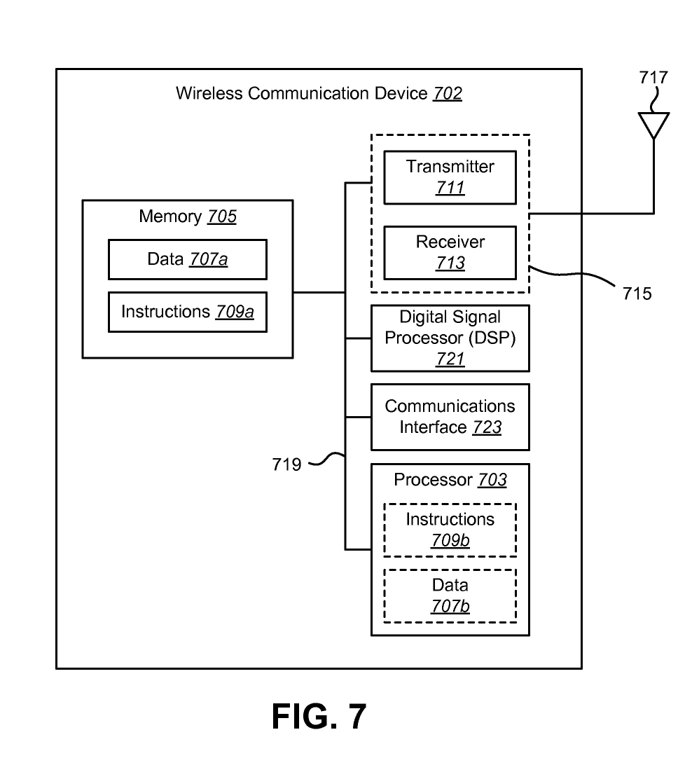

FIG. 7 illustrates certain components that may be included within a wireless communication device 702. The wireless communication device 702 may be an access terminal, a mobile station, a user equipment (UE), etc. For example, the wireless communication device 702 may be the wireless communication device 102 of FIG. 1.

The wireless communication device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. The wireless communication device 702 may also include (not shown) multiple transmitters, multiple antennas, multiple receivers and/or multiple transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

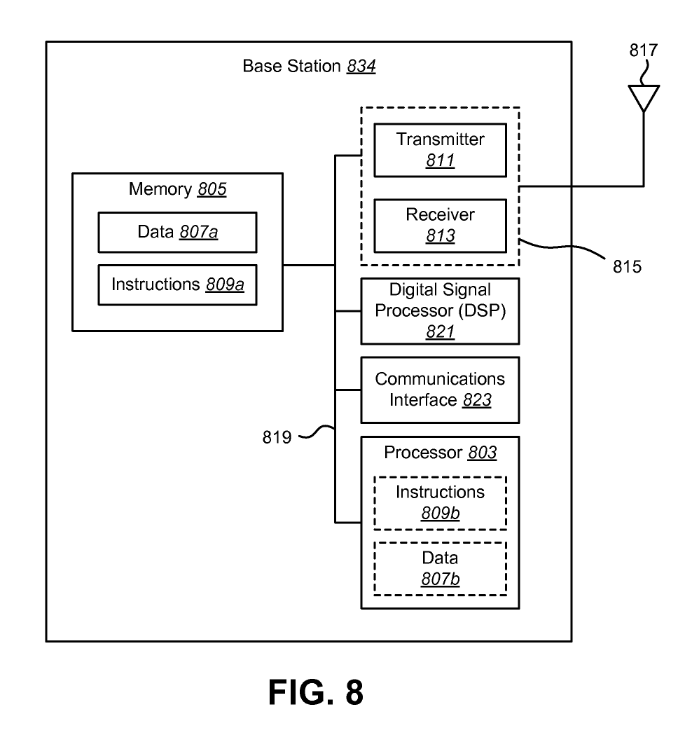

FIG. 8 illustrates certain components that may be included within a base station 834. A base station 834 may also be referred to as, and may include some or all of the functionality of, an access point, a broadcast transmitter, a NodeB, an evolved NodeB, etc. For example, the base station 834 may be the UMTS base station 234a or the GERAN base station 234b of FIG. 2.

The base station 834 may include a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the base station 834 of FIG. 8, in an alternative configuration, a combination of processors (e.g., an ARM and DSP) could be used.

The base station 834 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The base station 834 may also include a transmitter 811 and a receiver 813 to allow transmission and reception of signals to and from the base station 834. The transmitter 811 and receiver 813 may be collectively referred to as a transceiver 815. An antenna 817 may be electrically coupled to the transceiver 815. The base station 834 may also include (not shown) multiple transmitters, multiple receivers, multiple transceivers and/or additional antennas.

The base station 834 may include a digital signal processor (DSP) 821. The base station 834 may also include a communications interface 823. The communications interface 823 may allow a user to interact with the base station 834.

The various components of the base station 834 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3, FIG. 5 and FIG. 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for performing cell reselection by a wireless communication device, comprising:
determining that the wireless communication device should perform reselection to a target cell from a serving cell;
determining that the wireless communication device does not have paging channel information of the target cell; and
prioritizing reading paging channel information from a broadcast channel of the target cell over reading a paging channel of the serving cell.

2. The method of claim 1, wherein determining that the wireless communication device does not have paging channel information of the target cell is performed in response to determining that the wireless communication device should perform reselection to a target cell from a serving cell.

3. The method of claim 2, wherein prioritizing reading paging channel information from a broadcast channel of the target cell over reading a paging channel of the serving cell is performed in response to determining that the wireless communication device does not have paging channel information of the target cell.

4. The method of claim 1, wherein determining that the wireless communication device does not have the paging channel information of the target cell comprises determining that a system information type 3 (SI3) message of the target cell was not available in an internal stored list.

5. The method of claim 1, wherein prioritizing reading paging channel information from a broadcast channel of the target cell over reading a paging channel of the serving cell comprises:
canceling reading the paging channel of the serving cell; and
reading the broadcast channel of the target cell to obtain the paging channel information of the target cell.

6. The method of claim 5, wherein reading the broadcast channel of the target cell to obtain the paging channel information of the target cell is performed upon canceling reading the paging channel of the serving cell.

7. The method of claim 5, wherein reading the broadcast channel of the target cell to obtain the paging channel information of the target cell comprises decoding a system information type 3 (SI3) message of the target cell.

8. The method of claim 7, further comprising entering idle mode on the target cell upon decoding the system information type 3 (SI3) message of the target cell without decoding other system information blocks on the broadcast channel of the target cell.

9. The method of claim 8, wherein entering idle mode on the target cell upon decoding the system information type 3 (SI3) message of the target cell without decoding other broadcast channel information from the target cell comprises avoiding a page reorganization mode.

10. The method of claim 1, wherein the cell reselection is being performed in a Universal Mobile Telecommunications System (UMTS).

11. The method of claim 1, wherein the wireless communication device comprises a User Equipment (UE).

12. An apparatus for performing cell reselection, comprising:
a processor;
memory in electronic communication with the processor; and
instructions stored in the memory, the instructions being executable by the processor to:
determine that the apparatus should perform reselection to a target cell from a serving cell;
determine that the apparatus does not have paging channel information of the target cell; and
prioritize reading paging channel information from a broadcast channel of the target cell over reading a paging channel of the serving cell.

13. The apparatus of claim 12, wherein the instructions executable to determine that the apparatus does not have the paging channel information of the target cell comprise instructions executable to determine that a system information type 3 (SI3) message of the target cell was not available in an internal stored list.

14. The apparatus of claim 12, wherein the instructions executable to prioritize reading paging channel information from a broadcast channel of the target cell over reading a paging channel of the serving cell comprise instructions executable to:
cancel reading the paging channel of the serving cell; and
read the broadcast channel of the target cell to obtain the paging channel information of the target cell.

15. The apparatus of claim 14, wherein the instructions executable to read the broadcast channel of the target cell to obtain the paging channel information of the target cell comprise instructions executable to decode a system information type 3 (SI3) message of the target cell.

16. The apparatus of claim 15, wherein the instructions are further executable to enter idle mode on the target cell upon decoding the system information type 3 (SI3) message of the target cell without decoding other system information blocks on the broadcast channel of the target cell.

17. The apparatus of claim 16, wherein the instructions executable to enter idle mode on the target cell upon decoding the system information type 3 (SI3) message of the target cell without decoding other broadcast channel information from the target cell comprises the instructions executable to avoid a page reorganization mode.

18. A wireless communication device for performing cell reselection, comprising:
means for determining that the wireless communication device should perform reselection to a target cell from a serving cell;
means for determining that the wireless communication device does not have paging channel information of the target cell; and
means for prioritizing reading paging channel information from a broadcast channel of the target cell over reading a paging channel of the serving cell.

19. The wireless communication device of claim 18, wherein the means for determining that the wireless communication device does not have the paging channel information of the target cell comprise means for determining that a system information type 3 (SI3) message of the target cell was not available in an internal stored list.

20. The wireless communication device of claim 19, wherein the means for prioritizing reading paging channel information from a broadcast channel of the target cell over reading a paging channel of the serving cell comprise:
means for canceling reading the paging channel of the serving cell; and
means for reading the broadcast channel of the target cell to obtain the paging channel information of the target cell.

21. The wireless communication device of claim 20, wherein the means for reading the broadcast channel of the target cell to obtain the paging channel information of the target cell comprise means for decoding a system information type 3 (SI3) message of the target cell.

22. The wireless communication device of claim 21, further comprising means for entering idle mode on the target cell upon decoding the system information type 3 (SI3) message of the target cell without decoding other system information blocks on the broadcast channel of the target cell.

23. The wireless communication device of claim 22, wherein the means for entering idle mode on the target cell upon decoding the system information type 3 (SI3) message of the target cell without decoding other broadcast channel information from the target cell comprise means for avoiding a page reorganization mode.

24. A computer-program product for performing cell reselection, the computer-program product comprising a non-transitory computer-readable medium having instructions thereon, the instructions comprising:
code for causing a wireless communication device to determine that the wireless communication device should perform reselection to a target cell from a serving cell;
code for causing the wireless communication device to determine that the wireless communication device does not have paging channel information of the target cell; and
code for causing the wireless communication device to prioritize reading paging channel information from a broadcast channel of the target cell over reading a paging channel of the serving cell.

25. The computer-program product of claim 24, wherein the code for causing the wireless communication device to determine that the wireless communication device does not have the paging channel information of the target cell comprises code for causing the wireless communication device to determine that a system information type 3 (SI3) message of the target cell was not available in an internal stored list.

26. The computer-program product of claim 24, wherein the code for causing the wireless communication device to prioritize reading paging channel information from a broadcast channel of the target cell over reading a paging channel of the serving cell comprises:
code for causing the wireless communication device to cancel reading the paging channel of the serving cell; and
code for causing the wireless communication device to read the broadcast channel of the target cell to obtain the paging channel information of the target cell.

27. The computer-program product of claim 26, wherein the code for causing the wireless communication device to read the broadcast channel of the target cell to obtain the paging channel information of the target cell comprises code for causing the wireless communication device to decode a system information type 3 (SI3) message of the target cell.

28. The computer-program product of claim 27, further comprising code for causing the wireless communication device to enter idle mode on the target cell upon decoding the system information type 3 (SI3) message of the target cell without decoding other system information blocks on the broadcast channel of the target cell.

29. The computer-program product of claim 28, wherein the code for causing the wireless communication device to enter idle mode on the target cell upon decoding the system information type 3 (SI3) message of the target cell without decoding other broadcast channel information from the target cell comprises code for causing the wireless communication device to avoid a page reorganization mode.

30. The computer-program product of claim 24, wherein the cell reselection is being performed in a Universal Mobile Telecommunications System (UMTS).
